(19) United States
(12) Patent Application Publication
(10) Pub. No.: US 2007/0051146 A1
(43) Pub. Date: Mar. 8, 2007

(54) KEY AND LOCK SYSTEM PROVIDING SECURITY AGAINST FRAUDULENT COPYING

(75) Inventors: Pedro M. Recondo Carayalde, San Sebastian (ES); Jose Alcelay Bea, San Sebastian (ES)

Correspondence Address: LUCAS & MERCANTI, LLP, 475 PARK AVENUE SOUTH, 15TH FLOOR, NEW YORK, NY, 10016, US

(73) Assignee: TALLERES DE ESCORIAZA, S.A., IRUN (ES)

(21) Appl. No.: 11/470,406

(22) Filed: Sep. 6, 2006

(30) Foreign Application Priority Data
Sep. 6, 2005 (ES) 200502172

(51) Int. Cl. E05B 19/06

(52) U.S. Cl. 70/409

(57) ABSTRACT

The key of the key and lock system has a blade with at least two zones of different thickness, a nominal thickness zone and a reduced thickness zone. The reduced thickness zone has a displaceable element having a length which exceeds the thickness of the reduced thickness zone and is less than or equal to the nominal thickness zone. The slot of the lock has a recessed longitudinal profile where the size of the recesses is equal to the excess dimension of the displaceable element. At least one radial pivot is diametrically aligned with a security pin in the slot. The radial pivot protrudes inside the slot by an amount equal to the excess dimension of the displaceable element. When the key is fully inserted inside the slot, the displaceable element is situated between the radial pivot and the security pin and allows the lock to open.

### FIELD OF THE INVENTION

This invention relates to a system for locks which is designed to improve security against fraudulent copying of the key and, therefore, against attempts to force the associated lock, in particular intended for keys called “flat keys” in that they have combination keying means cut in the larger sides of the blade.

### BACKGROUND ART

Many solutions are known in this sector. One of them consists in a bolt which is perpendicular to the flat body of the blade and is installed through the nominal thickness of the blade with the capacity to move longitudinally so as to protrude on one side or the other of this blade. Another known solution consists in that it involves, in place of said bolt, a ball with a similar location and capacity to move, emerging on one side or the other of the blade. A solution is also known where a piece is housed in the nominal thickness of the blade in the manner of a bell clapper with the capacity to move both in the transverse direction of the blade and laterally inside said thickness thereof. Another solution consists in a kind of rocker piece which is housed inside the nominal thickness of the blade and which pivots in a direction transverse with respect thereto; when one end of the rocker piece is acted on by a stress, the other end protrudes on one side or the other of the blade. Another known solution consists in respective pins which are retractable against a spring and are installed in the opposite edges of the blade and in the same transverse plane thereof. All these solutions have in common the fact that functioning thereof is subject to movements of very small amplitude. Therefore, the assembly of the pin and counter-pin which is associated with these parts incorporated in the tip of the blade has only this small amplitude of movement available in order to ensure locking or release of rotation of the rotating piece within the fixed piece. Therefore, the locking conditions are critical, this favoring action on the part of the thief to reproduce something which achieves the same aim as the security means incorporated in the legal key, whereby it must be remembered in this connection that the thief who attempts to force a lock aims precisely to breach this specific barrier barring his access, albeit it at the cost of it being no longer utilizable, and, in order to achieve this aim, it may be sufficient to render unutilizable precisely the security device which this key incorporates and which differentiates it from other keys, the latter, as regards the remaining combination keying means for opening thereof, being similar and well known by the thief.

### DESCRIPTION OF THE INVENTION AND ITS ADVANTAGES

In view of this situation, the invention involved here is characterized in that the blade of the key has at least two zones of different thickness, i.e. a zone of nominal thickness and a zone of reduced thickness; in that in the zone of reduced thickness there is a first displaceable element which is installed with the possibility of moving freely through the thickness of the blade and, with respect to the transverse direction of the blade, this first displaceable element has a length which exceeds the thickness of said zone of reduced thickness and which is less than or equal to that of said zone of nominal thickness; in that the slot of the rotating piece for insertion of the blade has a recessed longitudinal profile where the size of the recesses is equal to said excess dimension of the first displaceable element with respect to the thickness of the zone of reduced thickness and in that it causes in the displaceable element of the key a first linear movement towards the security pin in the rotating piece; in that in the rotating piece there is at least one first radial pivot which, by means of the slot, is diametrally aligned with a first security pin which causes in the displaceable element of the key a second linear movement which, in conjunction with a first security counter-pin, is capable of ensuring locking/release of rotation of this rotating piece, the first radial pivot of which protrudes inside the slot by an amount equal to said excess dimension of the first displaceable element with respect to the thickness of the zone of reduced thickness; and in that, with respect to the position of the key fully inserted inside its slot, the first displaceable element remains situated between the first radial pivot and the position of the first security pin keyed with the first security counter-pin.

This proposed composition differs from that known hitherto based on situating movable elements in the nominal thickness of the blade and ensuring that the slot for insertion of this blade in the rotating piece is straight and has a uniform cross-section along its whole length; these conditions arising from the limited amplitude of movement of the various security means used in the solutions described above.

Instead, now a key is used where the blade has different thicknesses and is inserted inside a key slot which has a profile recessed in the form of a labyrinth which, along the insertion path of the key, interacts with the displaceable element. In this connection, the invention envisages that said first displaceable element is arranged in a zone of reduced thickness situated in the tip of the blade; since the displaceable element is installed in a smaller thickness of the blade, it protrudes by a greater amount and, therefore, has a greater capacity for operational travel which is directly exploited by the associated assembly of security pin/security counter-pin so that its travel between the states where rotation of the rotating piece is locked and released is greater (thereby increasing the bolt effect) and consequently so that the security is increased. In the description of the preferred embodiment provided further below with the aid of the accompanying drawings, ways of forming the recessed profile of the key slot are considered.

According to another object of the invention, it is envisaged that, when there is no key inserted inside the slot, the first security pin is retracted inside the fixed piece with its tip flush with the wall of the slot. This solution has the great advantage that it makes it difficult for the thief to detect from outside the location of the security means and, therefore, how to devise the tool necessary for breaching this security device.

### DRAWINGS AND REFERENCE NUMBERS

In order to understand better the nature of the invention, in the accompanying drawings an industrial embodiment is shown purely by way of an illustrative and non-limiting example.

FIG. 1 shows a cylinder with key (1) according to the invention, viewed from the bottom of the slot (6), together with an enlargement of the longitudinal section indicated therein. This longitudinal section shows the key (1) partially inserted, with the first displaceable element (5) making contact against a first step (7) in the slot (6).

FIG. 2 is a view (on a smaller scale), like the longitudinal section of FIG. 1, showing the key (1) in a more advanced position, making contact against a second step consisting of a first pivot (8) of the slot (6). This figure includes an enlarged detail of the part concerned.

FIG. 3 is similar to FIG. 2, but shows the key (1) fully inserted.

FIGS. 4 to 7 are similar to FIGS. 1 to 3, showing different positions of insertion of the key (1), including final insertion thereof, relating to an alternative embodiment of the invention.

FIG. 8 is a longitudinal section, like the ones above, but relating to an alternative embodiment of the invention.

FIG. 9 is a longitudinal section, like the ones above, but relating to an alternative embodiment of the invention.

These figures contain the following reference numbers:
1. Flat key
2. Blade of flat key (1)
2a. Zone of nominal thickness in the blade (2)
2b. Zone of reduced thickness in the blade (2)
3. Cylinder fixed piece for flat key (1)
4. Cylinder rotating piece for flat key (1)
5. First displaceable element
6. Slot in rotating piece for flat key (1)
7. Step in slot (6)
8. First radial pivot
9. First security pin
10. First security counter-pin
11. Step in slot (6)
12. Second radial pivot
13. Third radial pivot
14. Fourth radial pivot
15. Second security pin
16. Second security counter-pin
17. Second displaceable element

### DESCRIPTION OF A PREFERRED EMBODIMENT

With reference to the drawings and reference numbers listed above, the accompanying drawings show a preferred embodiment of the subject of the invention which concerns a key and lock system providing security against fraudulent copying thereof, in particular intended for keys (1) called “flat keys” in that they have combination keying means cut in the larger sides of the blade (2).

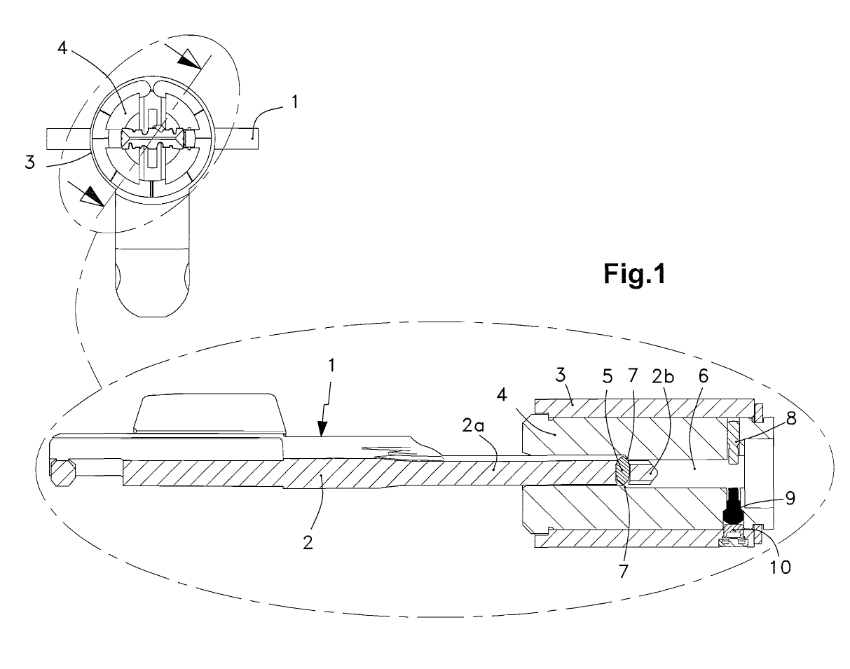

As shown in FIG. 1, the essential object of the invention consists in that the blade (2) of the key (1) has at least two zones of different thickness, i.e. a zone of nominal thickness (2a) and a zone of reduced thickness (2b); in that in the zone of reduced thickness (2b) there is a first displaceable element (5) which is installed with the possibility of moving freely through the thickness of the blade (2) and, with respect to the transverse direction of the blade (2), this first displaceable element (5) has a length which exceeds the thickness of said zone of reduced thickness (2b) and which is less than or equal to that of said zone of nominal thickness (2a); in that the slot (6) of the rotating piece (4) for insertion of the blade (2) has a recessed longitudinal profile where the size of recesses is equal to said excess dimension of the first displaceable element with respect to the thickness of the zone of reduced thickness (2b) which causes in the displaceable element of the key a first linear approach movement; in that in the rotating piece (4) there is at least one first radial pivot (8) which causes in the displaceable element of the key a second linear actuating movement which, by means of the slot (6), is diametrally aligned with a first security pin (9) which, in conjunction with a first security counter-pin (10), is capable of ensuring locking/release of rotation of this rotating piece (4), the first radial pivot (8) of which protrudes inside the slot (6) by an amount equal to said excess dimension of the first displaceable element (5) with respect to the thickness of the zone of reduced thickness (2b); and in that, with respect to the position of the key (1) fully inserted inside its slot (6), the first displaceable element (5) remains situated between the first radial pivot (8) and the position of the first security pin (9) keyed with the first security counter-pin (10). In this context the invention envisages that the zones of reduced thickness (2b) may embrace all or part of the width of the blade (2) and that there is a zone of reduced thickness (2b) in the tip of the blade (2) and that said first displaceable element (5) is precisely in this zone of reduced thickness (2b) situated in the tip of the blade (2).

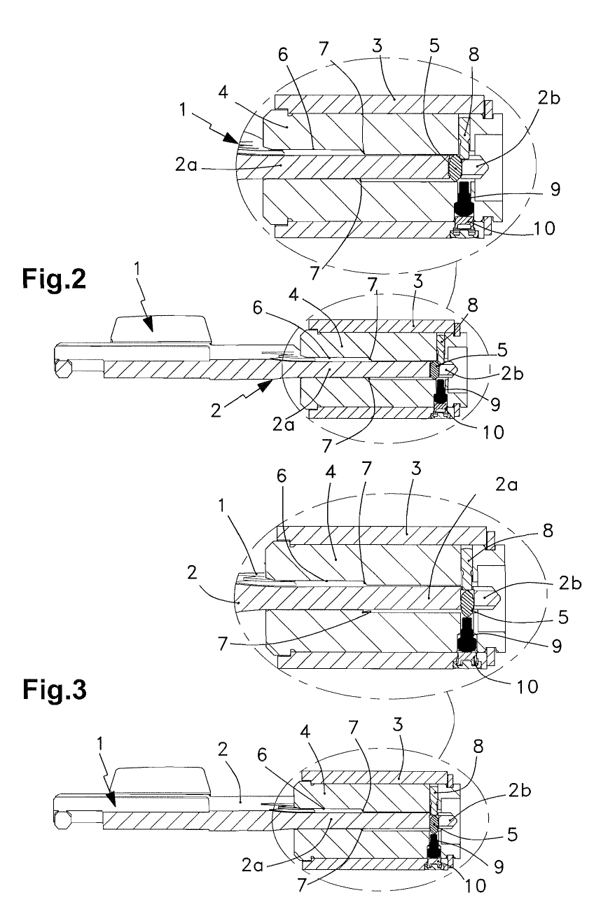

In accordance with this composition a preferred embodiment is that shown in FIGS. 1 to 3 where it can be seen that in the tip of the blade (2) there is a zone of reduced thickness (2b) which has, incorporated therein, a first displaceable element (5). This embodiment shows an alternative preferred embodiment of the recessed profile of the slot (6) with a number of steps (7) cut therein by means of broaching. The operating principle may be clearly understood with reference to said FIGS. 1 to 3; during a first step where the key (1) is inserted, the first displaceable element (5) projects from one of the sides of the zone of nominal thickness (2a) of the blade (2) and also with respect to both sides of the zone of reduced thickness (4b) until it first comes up against a step (7) which causes it to protrude from the other side of the zone of nominal thickness (2a) of the blade (2) while still protruding from both sides of the zone of reduced thickness (2b), this being possible owing to the existence of another step (7) in the opposite direction; the key continues its advancing movement until (FIG. 2) it reaches a second stop which is formed by the tip of the first radial pivot (8) and pushes the first displaceable element (5) against the first security pin (9) and the latter (FIG. 3) in turn moves by the amount necessary to produce releasing of the locking action in conjunction with the first security counter-pin (10). It should be noted that in this process, owing to the particular construction of the labyrinth provided for the recessed profile of the slot (6), the first displaceable element (5) has performed two successive movements in the same direction, it being possible to appreciate the gain in space available for actuation of the proposed security device.

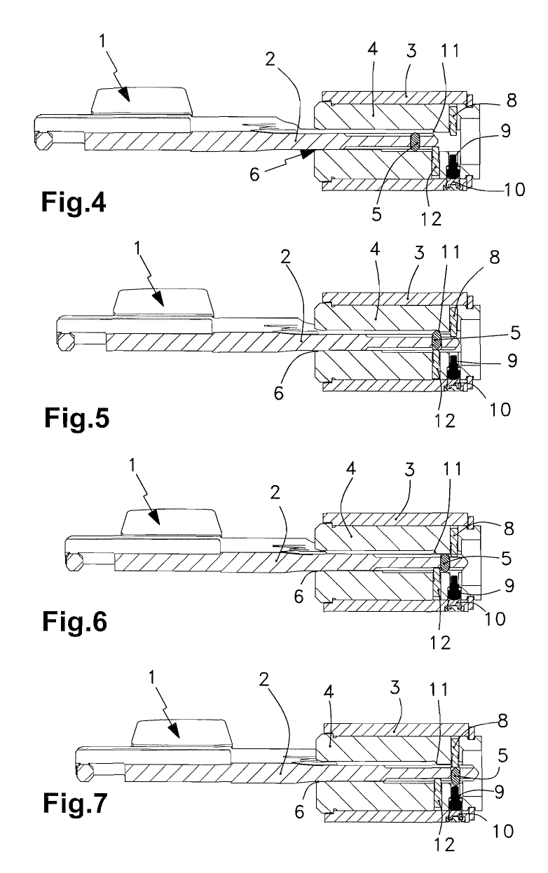

An alternative embodiment envisaged in the invention (FIGS. 4 to 7) is that the recessed longitudinal profile of the slot (6) consists of steps (11) cut in respect of only one of the larger sides of the blade (2), in conjunction with a second radial pivot (12) which is situated opposite said step (11) and which, as regards insertion of the key (1), is situated in front of said first security pin (9) and protrudes inside the slot (6) by the same amount as the first radial pivot (8). In this case, merely observing the figures it is possible to appreciate that the first stop which displaces the first displaceable element (5) is provided by the second radial pivot (12), while the second stop is provided, as mentioned before, by the first radial pivot (8); as a consequence of this configuration of the internal labyrinth of the slot (6), the first displaceable element (5) has now undergone two identical movements in opposite directions, making it extremely difficult for the thief to locate and reach the assembly of the first security pin (9) and first security counter-pin (10) which determines rotational locking of the rotating piece (4).

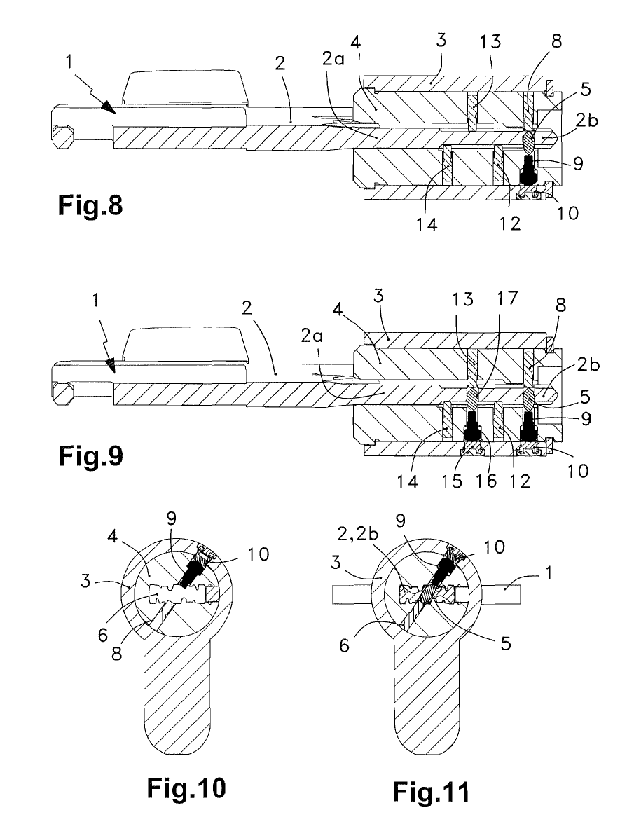

Other alternatives which makes it very difficult to reach said security assembly are based on the fact that the recessed profile of the slot (6) forms a double labyrinth. One possibility in this connection is that shown in FIG. 8 where there a number of radial pivots, i.e. a third radial pivot (13) and fourth radial pivot (14), which precede by the same amount said first radial pivot (8) and second radial pivot (12), respectively, and which are situated in the section of the rotating piece (4) where said step (11) is formed. Another possibility is that shown in FIG. 9 and which presupposes a duplication of the means used in FIG. 1; it consists in that, in the same manner as said first security pin (9) and first security counter-pin (10), there is an assembly consisting of a second security pin (15) and second security counter-pin (16), this assembly being arranged between said second radial pivot (12) and fourth radial pivot (14) and being aligned axially with said third radial pivot (13), while there is a second displaceable element (17) which, in the fully inserted position of the key, operates in conjunction with said third radial pivot (13) and with said assembly consisting of the second security pin (15) and second security counter-pin (16).

Another particular feature of the invention consists in that said first displaceable element (5) and second displaceable element (17) operate in planes which are oblique with respect to that of the blade (2) and in which they act in conjunction with the respective assemblies consisting of first radial pivot (8)/first security pin (9)/first security counter-pin (10) and third radial pivot (13)/second security pin (15)/second security counter-pin (16). The cross-sections in FIGS. 10 and 11 show this oblique arrangement (with reference to the embodiment of FIG. 3) for the conditions where there is no key (1) inside the slot (6) (locking) and where the key (1) is correctly inserted (unlocking), respectively.

1. A key and lock system providing security against fraudulent copying thereof, comprising a flat key having keying means cut in the larger sides of a blade, wherein the blade of the key has at least two zones of different thickness, a zone of nominal thickness and a zone of reduced thickness; the zone of reduced thickness having a first displaceable element which moves freely through the thickness of the blade and, the transverse direction of the blade, the first displaceable element having a length which exceeds the thickness of said zone of reduce thickness and which is less than or equal to that of said zone of nominal thickness; a slot of a rotating piece for insertion of the blade has a recessed longitudinal profile where the size of recesses is equal to said excess dimension of the first displaceable element with respect to the thickness of the zone of reduced thickness; the rotating piece having at least one first radial pivot which, by means of the slot, is diametrally aligned with a first security pin which, in conjunction with a first security counterpin, is capable of ensuring locking/release of rotation of the rotating piece, the first radial pivot protrudes inside the slot by an amount equal to said excess dimension of the first displaceable element with respect to the thickness of the zone of reduced thickness; and when the key is fully inserted inside the slot, the first displaceable element remains situated between the first radial pivot and the first security pin keyed with the first security counter-pin.

2. The key and lock system of claim 1, wherein when the key is not inserted inside the slot, the first security pin is retracted inside the fixed piece with its tip flush with the wall of the slot.

3. The key and lock system of claim 1, wherein the recessed longitudinal profile of the slot consists of steps cut therein.

4. The key and lock system of claim 1, wherein the zones of reduced thickness embrace all or part of the width of the blade.

5. The key and lock system of claim 4, wherein the zone of reduced thickness is in the tip of the blade.

6. The key and lock system of claim 5, wherein said first displaceable element is in a zone of reduced thickness situated in the tip of the blade.

7. The key and lock system of claim 1, wherein the recessed longitudinal profile of the slot consists of steps cut in respect of only one of the larger sides of the blade, in conjunction with a second radial pivot which is situated opposite said step and which, as regards insertion of the key, is in front of said first security pin and protrudes inside the slot by the same amount as the first radial pivot.

8. The key and lock system of claim 7, further comprising a number of radial pivots, a third radial pivot and fourth radial pivot which precede by the same amount said first radial pivot and second radial pivot, respectively, and which are situated in the section of the rotating piece in which said step is formed.

9. The key and lock system of claim 8, further comprising an assembly consisting of a second security pin and second security counter-pin which is arranged between said second radial pivot and fourth radial pivot and which is aligned axially with said third radial pivot, a second displaceable element which, in the fully inserted position of the key, operates in conjunction with said third radial pivot and with said assembly consisting of a second security pin and second security counter-pin.

10. The key and lock system of claim 8, wherein said first displaceable element and second displaceable element operate in planes which are oblique with respect to that of the blade and act in conjunction with the respective assemblies consisting of first radial pivot, first security pin, first security counter-pin and third radial pivot, second security pin, second security counter-pin.

11. The key and lock system of claim 1, wherein the overall movement of the displaceable element in the key is a consequence of a double multiplying effect, first over a step of the slot and then over a first radial pivot positioned rigidly interfering with the slot.

12. The key and lock system of claim 8, wherein the number of radial pivots, third radial pivot and fourth radial pivot, which precede by the same amount said first radial pivot and second radial pivot, respectively, and which are situated in the section of the rotating piece arranged so that they produce a labyrinth which causes consecutive up and down movements of any foreign body which may be introduced into the slot with the aim of activating the security pin.

13. The key and lock system of claim 8, wherein there are a number of radial pivots, third radial pivot and fourth radial pivot, which precede by the same amount said first radial pivot and second radial pivot, respectively, and which are situated in the section of the rotating piece, are made of hardened materials which make it difficult to introduce foreign tools inside the slot with the aim of activating the security pin.
